(19) United States
(12) Patent Application Publication
(10) Pub. No.: US 2015/0113180 A1
(43) Pub. Date: Apr. 23, 2015

(54) Method for Servicing a Field Device

(71) Applicant: Endress + Hauser GmbH + Co. KG, Maulburg (DE)

(72) Inventors: Marc Baret, Kembs (FR); Eric Birgel, Schopfheim (DE); Julien Fischer, Saint Louis (FR); Martine Lefebvre, Blotzheim (FR); Andrea Seger, Zell (DE); Mathieu Weibel, Greenwood, IN (US)

(21) Appl. No.: 14/384,434

(22) PCT Filed: Feb. 22, 2013
(86) PCT No.: PCT/EP2013/053574

§ 371 Date: Sep. 11, 2014

(30) Foreign Application Priority Data
Mar. 23, 2012 (DE) 10 2012 102 516.9

(51) Int. Cl. G06F 13/42; H04W 4/00

(52) U.S. Cl. CPC G06F 13/4221; H04W 4/008; H04W 88/18
USPC 710/36

(57) ABSTRACT

A method for servicing a field device having a first wireless transmission module, preferably a transponder. An adapter is provided, which has a corresponding second wireless transmission module, preferably a reading device, for querying the transponder. The field device has, furthermore, a first communication interface for communication via a fieldbus, preferably a wired fieldbus, wherein the adapter has a second communication interface likewise for communication via the fieldbus, preferably a wired fieldbus. Data stored in a memory unit of the field device are wirelessly retrieved and transmitted to the adapter by means of the first transmission module and by means of the second transmission module, wherein the adapter is connected with a service device, and wherein by means of the retrieved data a connection is established between the field device and the service device via the field bus.

The invention relates to a method for servicing a field device. Furthermore, the invention relates to an arrangement for performing the method, wherein the arrangement comprises an adapter, a service device and a field device. Additionally, the invention relates to an adapter, a service device and a field device taken singly.

It is known from the state of the art to provide the housing of a field device with an RFID data carrier, so that information stored in the RFID data carrier can be queried contactlessly. Furthermore, it is known from DE 102008008072 A1 (U.S. Pat. No. 8,179,266) to connect this RFID data carrier with an internal electronics unit of the field device, so that signals from the RFID data carrier can be provided internally to the field device. To this end, the RFID data carrier can be writeable.

Furthermore, it is also known from DE 202006012632 U1 to apply RFID transponders as access control for a machine.

Different standards have been created for wireless data transmission. Thus, for example, an inductive coupling or near field coupling (NFC) can occur via magnetic fields. Data transmission and often also energy supply occurs, in such case, via a magnetic near field, which results from coils in a reading device and in a tag. The frequencies used in the case of such transmission lie at 135 kHz and 13.56 MHz and are set by the standards ISO 18000-2 and ISO 18000-3, respectively ISO 22536. Furthermore, it is known to utilize electromagnetic dipole fields for remote coupling. Here, data transmission and often also energy supply occurs via antennas, for example, dipole antennas or spiral antennas. The frequencies for this coupling lie at 433 MHz, 868 MHz and 2.45 GHz, as set by the standards ISO 18000-7, IS018000-6, respectively ISO 18000-4.

The conventional NFC-communication method has, however, the disadvantage that too much power is required for continuous data transmission, such as is the case, for example, in the parametering of a field device of process- and/or automation technology via a software tool for field device configuration.

Furthermore, in the case of currently known fieldbus systems, especially in the case, in which a large number of field devices are connected to the fieldbus, it is very time consuming to query field device specific data, such as, for example, the fieldbus addresses of the field devices, for example, using a service device connected to the fieldbus. Especially when a number of field devices of the same type are connected to a fieldbus, it is, in given cases, difficult for a user to select the right device.

An object of the invention is to enable simple and fast accessing of a field device via a fieldbus when the field device is connected to the fieldbus.

The object is achieved according to the invention by a method, an adapter, a service device, a field device, as well as an arrangement.

As regards the method, the object is achieved by a method as defined in claim 1.

As already mentioned, known from the state of the art are field devices that have a wireless transmission module. According to the invention, an adapter is equipped with a corresponding second wireless transmission module. By means of this adapter, data are retrieved from the memory unit of the field device and transmitted to the adapter. The adapter is then connected with the service device and the service device establishes a connection to the field device based on the retrieved data.

The transmission module of the adapter is, for example, a reading device for querying a transponder provided in the field device. For servicing the field device, thus, the proposed adapter enables in simple manner establishing a connection to the field device by means of the service device and the adapter. A user can by the adapter on-site in a plant of process automation technology retrieve data from the field device and based on this retrieved data establish via the fieldbus a connection to the field device.

Preferably, the data retrieved from the memory unit is the fieldbus address of the field device. The field device has a first communication interface for communication via the fieldbus and the adapter has a second communication interface for communication via the fieldbus. For connecting the adapter with the service device, another interface can be provided, via which the adapter is connected with the service device.

In a form of embodiment of the method, the data retrieved from the memory unit comprises one or more data of the following type: the firmware version of the field device, the serial number of the field device, the order number of the field device, the tag of the field device, the version of the electronic name plate of the field device, the fieldbus type, and/or the version of the device description of the field device. Based on at least one of these data, the service device can establish a connection to the field device and/or the servicing of the field device can be performed.

In an additional form of embodiment of the method, at start-up of the field device or upon a change in the aforementioned data, these data are written into the memory unit of the field device. Thus, there is always a current version of the data available in the memory unit of the field device and such can be transmitted via the first wireless transmission module to the adapter.

In an additional form of embodiment of the method, the field device is connected to the fieldbus and then started up. After the field device is connected to the fieldbus and after the field device has been supplied with electrical energy, for example, via the fieldbus, the fieldbus address or data of another aforementioned type is written into the memory unit of the field device. The connecting of the field device to the fieldbus and the following electrical current supply of the field device is also referred to as start-up in connection with the present invention. The fieldbus address of a field device can already be set before the connecting of the field device, by means of a DIP switch on the field device. DIP switches are, however, often arranged below a cover, i.e. within the housing of the field device. After startup of the field device, this fieldbus address can be written into the memory unit. Furthermore, the fieldbus address of a field device can also be granted by a superordinated unit. In this case, the field device obtains its fieldbus address only after the connecting of the field device to the fieldbus.

In a form of embodiment of the method, a number of field devices of the same type are connected to the fieldbus, wherein all these field devices have mutually differing fieldbus addresses. The terminology, field devices of the same type, means, in such case, field devices, which, for example, record the same measured variable, utilize the same measuring principle for recording this measured variable, make use of the same electronic equipment, and/or have the same name. Since field devices of the same type are only difficultly distinguished from one another via the fieldbus and a service device, the present invention represents an essential facilitating of the servicing of a field device on-site in a plant of process automation technology.

In an additional form of embodiment of the proposed method, the data from the memory unit of the field device are wirelessly retrieved and transmitted to the adapter by means of the adapter on-site in the immediate vicinity of the field device via the first transmission module of the field device and via the second transmission module of the adapter. In order to service a field device, a user thus need only go to the immediate vicinity of the field device. Via the adapter, then, for example, the data from the memory unit can be automatically transmitted to the adapter. The user must then only connect the adapter with the service device and so establish a connection with the field device. The service device can be, for example, a computing unit, such as, for example, a PC. Furthermore, for servicing, an operating program such as, for example, the Fieldcare program of the assignee can be used.

In a form of embodiment of the method, the field device includes a microprocessor, via which the memory unit can be accessed. Furthermore, also the first transmission module of the field device can have a microprocessor, via which the memory unit of the field device can also be accessed. Thus, a memory unit can be provided in the field device. The memory unit can be accessed, preferably alternately, both by the operating electronics as well as also by the first transmission module. The accessing of the memory unit by the first transmission module can be achieved both through an energy supply of the field device as well as also through an energy supply via the first transmission module. In the latter case, the energy supply is then won, for example, from the radio connection between the first and second transmission modules.

In an additional form of embodiment of the method, the first wireless transmission module is a passive transmission module, which is queried via an electrical and/or magnetic field, which is provided by the second transmission module. The second transmission module is, for example, a reading device for querying the first transmission module. On the other hand, also the reverse can be provided, in the case of which the first wireless transmission module is a reading device for querying the second transmission module.

In an additional form of embodiment of the method, the first and the corresponding second transmission modules are transmission modules working according to the RFID standard and/or the NFC standard. It has namely been found that especially an alternating operation according to the RFID- and the NFC standards can be used for an especially energy-saving transmission between two communication partners. In an additional form of embodiment of the method, the data transmitted from the memory unit of the field device to the adapter are transmitted to the service device after the connecting the adapter to the field device. To this end, such as already mentioned, an additional communication interface can be provided at the adapter for communication with the service device. The adapter is preferably a so called fieldbus modem that can be connected, on the one hand, to the fieldbus and, on the other hand, to a service device.

The object is, furthermore, achieved by an adapter for performing the method according to one of the preceding forms of embodiment.

The object is, furthermore, achieved by a service device for performing the method according to one of the preceding forms of embodiment.

The object is also achieved by a field device for performing the method according to one of the aforementioned forms of embodiment.

The object is, furthermore, achieved by an arrangement comprising an adapter, a service device and a field device for performing the method according to one of the aforementioned forms of embodiment.

The invention will now be explained in greater detail based on the appended drawing, the figures of which show as follows:

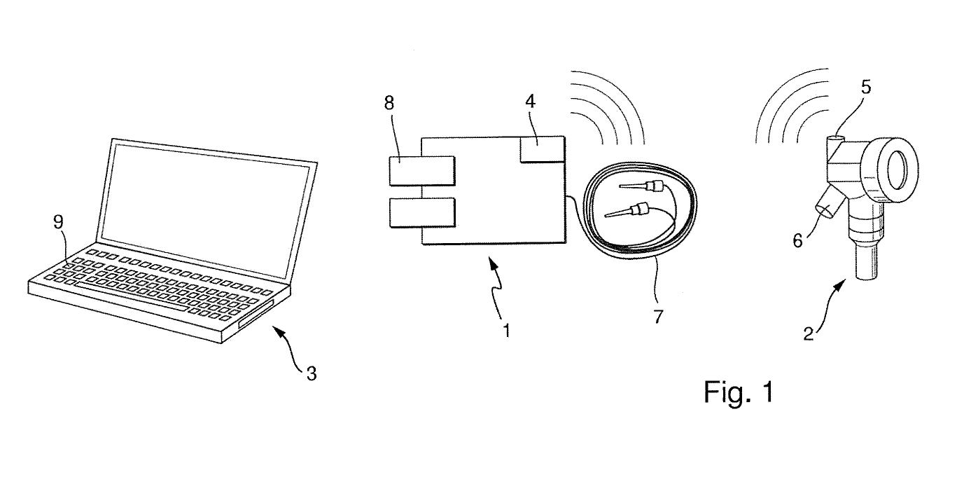

FIG. 1 a schematic representation of an arrangement comprising a field device, a service device and an adapter for performing the proposed method,

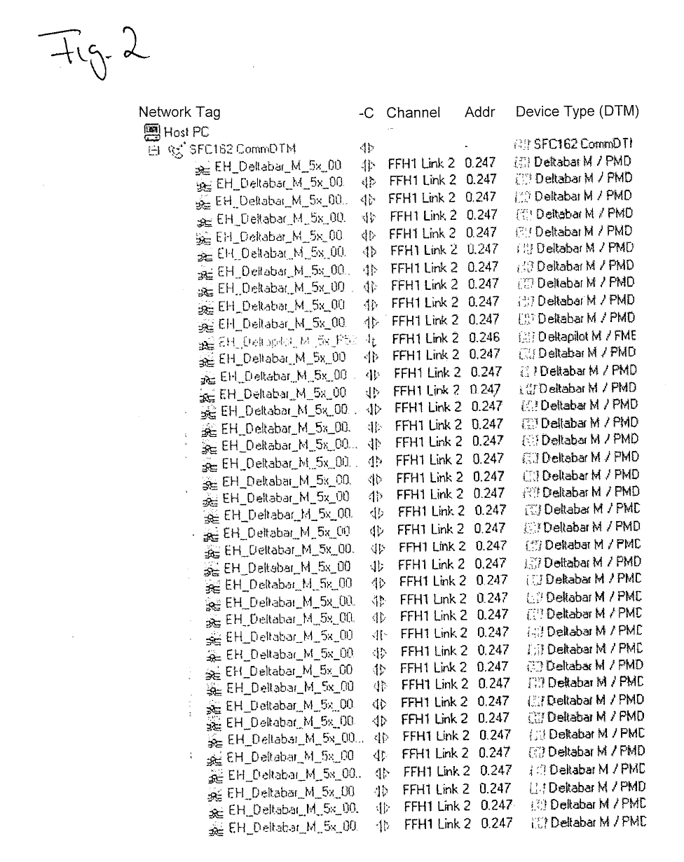

FIG. 2 by way of example, a list of participants on a fieldbus in a plant of process automation technology.

FIG. 1 shows a schematic representation of a field device having a first wireless transmission module 5. The wireless radio transmission is indicated, in such case, by the circular arcs beside the field device 2 and beside the adapter 1. Field device 2 is, for example, a sensor, an actuator or a display/service unit. The field device is connected with the fieldbus (not shown). For connection with the fieldbus, the field device 2 includes a cable connector 6, where a cable can be connected, in order to connect the field device 2 with the fieldbus.

Adapter 1 includes a second transmission module 4, via which data stored in a memory unit (not shown) of the field device 2 can be downloaded. To this end, a user goes on-site in the plant into the vicinity of the field device 2, so that data can be exchanged via the radio connection between the first and second transmission modules 4, 5. Adapter 1 is a fieldbus modem, which serves primarily for communication via the fieldbus. The second transmission module 5 is integrated into the fieldbus modem, so that the fieldbus modem enables data exchange directly between the fieldbus modem and the field device.

After the data have been transmitted from the memory unit of the field device 2 to the fieldbus modem functioning as adapter 1, the fieldbus modem can be connected with the service device 9, in this case, a portable computer. Alternatively, the fieldbus modem 1 can also already be connected with the service device 9 at the point in time, when the data is being downloaded from the memory unit of the field device 2. The fieldbus modem can, for example, be plugged into a port 3 of the computer. Via a cable connection 7, the fieldbus modem can then be connected with the fieldbus (not shown) and the field device 2 serviced using the service device 9 via the fieldbus. In connection with this, the data transmitted from the memory unit of the field device 2 via the radio connection are utilized. The data is preferably the fieldbus address of the field device 2.

FIG. 2 shows a list of participants on a fieldbus. Via such a fieldbus, a number of participants in an industrial plant are connected with one another and exchange data among one another and/or with a superordinated control unit, which serves for controlling the process running in the plant. As can be seen from the list, it is often the case that a plurality of field devices of the same type are present in an industrial plant and connected with one another via a fieldbus. In the present case, the field devices of the same type are pressure measuring devices of the type, Deltabar M.

During startup of the field device, parameters such as the serial number, the order number, the PD Tag, the device ID and the device revision etc. are written into the memory unit, which can be a FRAM. Startup occurs, as a rule, after the connecting of the field device to the fieldbus, since field devices usually, as well as also in the present case, are supplied with energy via the fieldbus. These parameters written into the memory unit serve, among other things, for unique identification of a field device on the fieldbus. The problem is that the scanning of devices on the fieldbus is very time consuming, since, for each field device, first the field device data must be read, in order to show such data in the network. This fieldbus scanning must also be performed, when one would like to parameter with an operating program, such as e.g. the FieldCare program, only one device of 32 but, however, does not know the field device address. There exists, for instance, a very complicated network list, which contains the addresses of the field devices, thus a list as shown in FIG. 2, in which one must spend some time searching, in order to find a certain field device. This problem is solved in the present invention by associating an RFID tag with a field device.

A fieldbus modem with integrated RFID reading device can automatically identify a field device, as soon as it comes into the vicinity of the field device and into the range of the radio transmission, whereupon the address, the channel and/or the fieldbus tag of the field device can be read out. With the help of this data, it is no longer necessary to scan the fieldbus. The method is, thus, of great advantage when it is desired to service a field device. A connection to a field device can, thus, be established in simple manner and the time needed for scanning or manual selection of the right DTM saved.

### LIST OF REFERENCE CHARACTERS

1 adapter (fieldbus modem)
2 field device
3 port for adapter (fieldbus modem)
4 second transmission module
5 first transmission module
6 cable connector for fieldbus connection
7 cable connector for fieldbus connection
8 plug-in contacts
9 service device

1-15. (canceled)

16. A method for servicing a field device having a first wireless transmission module; an adapter is provided, which has a corresponding second wireless transmission module, for querying the transponder, the method comprising the steps of:
providing the field device with a first communication interface for communication via a fieldbus, preferably a wired fieldbus;
providing the adapter has a second communication interface likewise for communication via the fieldbus, preferably a wired fieldbus;
wirelessly retrieving data stored in a memory unit of the field device by means of the first transmission module and by means of the second transmission module and transmitted to the adapter;
connecting the adapter with a service device; and
by means of the retrieved data a connection is established between the field device and the service device via the fieldbus.

17. The method as claimed in claim 16, wherein:
the data retrieved from the memory unit comprises the fieldbus address of the field device.

18. The method as claimed in claim 16, wherein:
the data retrieved from the memory unit comprises one or more data of the follow type:
the firmware-version of the field device;
the serial number of the field device;
the order number of the field device;
the tag of the field device;
the version of the electronic name plate of the field device;
the type of the fieldbus; and
the version of the device description of the field device.

19. The method as claimed in claim 18, wherein:
the data are written into the memory unit of the field device at start-up of the field device or upon a change of the data.

20. The method as claimed in claim 16, wherein:
the field device is connected to the fieldbus; and
the field device is started up after the connecting of the field device; and
after startup of the field device the fieldbus address of the field device is written into the memory unit of the field device.

21. The method as claimed in claim 16, wherein:
a plurality of field devices of the same type are connected to the fieldbus and the field devices have fieldbus addresses differing from one another.

22. The method as claimed in claim 16, wherein:
the data are wirelessly retrieved and transmitted via the first and second transmission modules from the memory unit of the field device by means of the adapter in the immediate vicinity of the field device.

23. The method as claimed in claim 16, wherein:
the memory unit is accessed, preferably alternately, on the one hand, via a microprocessor of an operating electronics of the field device and, on the other hand, via a microprocessor of the first transmission module of the field device.

24. The method as claimed in claim 16, wherein:
the first wireless transmission module is a passive transmission module, which is queried by an electrical and/or magnetic field, which is provided by the second transmission module, which is a reading device for querying the first transmission module.

25. The method as claimed in claim 16, wherein:
the first and the corresponding second transmission modules are transmission modules working according to the RFID standard and/or NFC standard.

26. The method as claimed in claim 16, wherein:
the data transmitted from the memory unit to the adapter are transmitted to the service device after connecting the adapter to the service device; and
for this purpose preferably an additional communication interface is provided at the adapter for communication with the service device.

27. An adapter for performing the method as claimed in claim 16.

28. A service device for performing the method of claim 16.

29. A field device for performing the method of claim 16.

30. An arrangement comprising:
an adapter; a service device; and a field device for performing the method as claimed in claim 16.
